(19) United States
(12) Patent Application Publication
(10) Pub. No.: US 2020/0147683 A1
(43) Pub. Date: May 14, 2020

(54) FORMING METHOD OF METAL LAYER

(71) Applicant: Industrial Technology Research Institute, Hsinchu (TW)

(72) Inventors: Yi-Tsung Pan, Tainan City (TW); Jer-Young Chen, Hsinchu City (TW); Chuan-Sheng Chuang, Tainan City (TW); Shinn-Jen Chang, Hsinchu City (TW); Chi-San Chen, Kaohsiung City (TW); Li-Shing Chou, Tainan City (TW)

(73) Assignee: Industrial Technology Research Institute, Hsinchu (TW)

(21) Appl. No.: 16/676,444

(22) Filed: Nov. 7, 2019

Related U.S. Application Data
(60) Provisional application No. 62/758,520, filed on Nov. 10, 2018.

(51) Int. Cl. B22F 1/00; B22F 3/105

(52) U.S. Cl. CPC B22F 1/0088; B22F 1/0085; B33Y 10/00; B22F 2003/1056; B22F 3/1055

(57) ABSTRACT

Provided is a forming method of a metal layer suitable for a 3D printing process. The method includes the steps of providing a plurality of metal particles on a substrate; applying an oxide-removing agent to the metal particles to remove metal oxides on the metal particles; at a first temperature, performing a first heat treatment on the metal particles for which the metal oxides are removed to form a near shape; and at a second temperature, performing a second heat treatment on the near shape to form a sintered body. The first temperature is lower than the second temperature.

### CROSS-REFERENCE TO RELATED APPLICATION

This application claims the priority benefit of U.S. provisional application Ser. No. 62/758,520, filed on Nov. 10, 2018. The entirety of the above-mentioned patent application is hereby incorporated by reference herein and made a part of this specification.

### TECHNICAL FIELD

The disclosure relates to a forming method of a metal layer, and more particularly to a forming method of a metal layer suitable for a three-dimensional (3D) printing process.

### BACKGROUND

In a general 3D printing process, after metal particles are provided on a substrate, the metal particles are heat-treated to form a dense sintered body of the metal particles to form a metal layer. However, after the metal particles are provided on the substrate, a layer of metal oxides is inevitably generated on the surface of the metal particles due to oxygen in the external environment. Since the metal oxides have a higher melting point than the metal, the heat treatment has to be performed at a higher temperature.

At present, metal particles having a metal oxide layer formed on the surface are mostly heat-treated by high-energy laser. The high-energy laser may simultaneously melt the metal oxide layer and the metal particles. However, the sintered body thus formed contains metal oxides, thus affecting the characteristics of the resulting metal layer.

### SUMMARY

The disclosure provides a forming method of a metal layer utilizing an oxide-removing agent to remove metal oxides on metal particles prior to high-temperature sintering.

The forming method of a metal layer of the disclosure is suitable for a 3D printing process and includes the following steps. A plurality of metal particles are provided on a substrate. An oxide-removing agent is applied to the metal particles to remove metal oxides on the metal particles. At a first temperature, a first heat treatment is performed on the metal particles for which the metal oxides are removed to form a near shape. At a second temperature, a second heat treatment is performed on the near shape to form a sintered body. The first temperature is lower than the second temperature.

In an embodiment of the disclosure, after the metal particles are provided on the substrate, the metal oxides on the metal particles are removed with an oxide-removing agent, and thus a near shape may be formed after a low-temperature heat treatment. As a result, the time for a subsequent high-temperature heat treatment may be effectively shortened, and a sintered body of high purity may be formed.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a flowchart of the steps of a forming method of a metal layer shown according to an embodiment of the disclosure.

FIG. 2A to FIG. 2C are cross-sectional views of a process of a forming method of a metal layer shown according to an embodiment of the disclosure.

FIG. 3A, FIG. 3B, and FIG. 3C are the results of low-temperature calcination of stainless-steel particles of the experimental examples and the comparative example.

### DETAILED DESCRIPTION OF DISCLOSED EMBODIMENTS

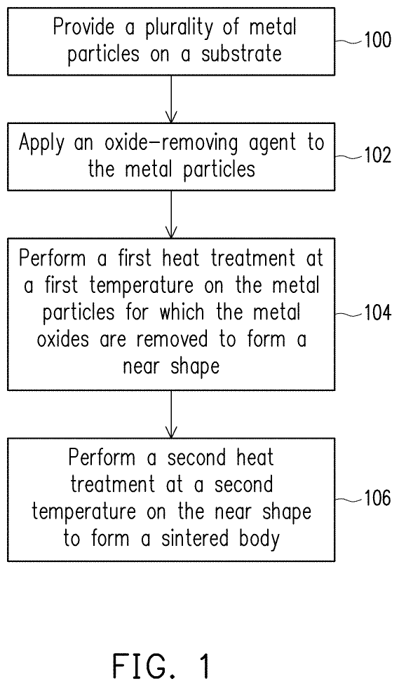

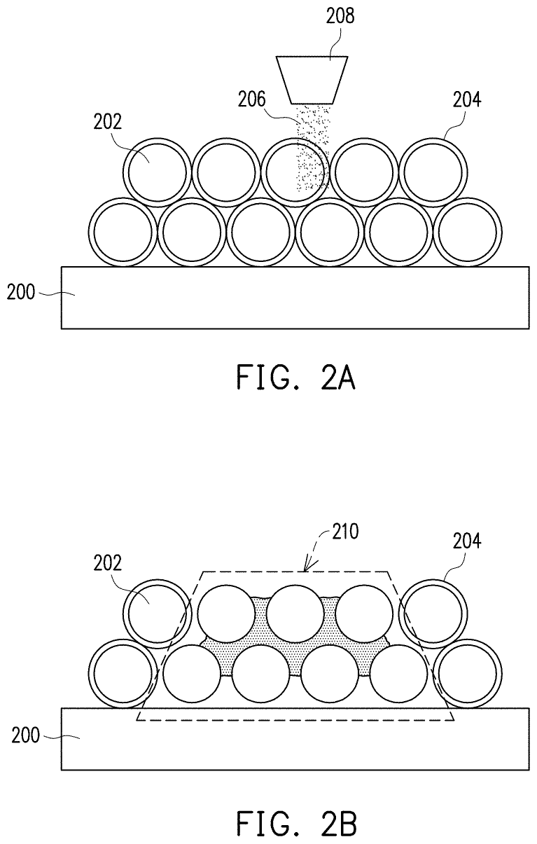

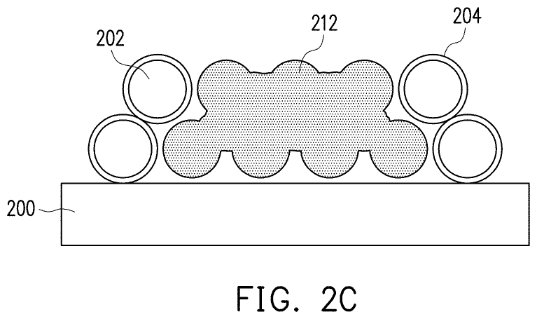

FIG. 1 is a flowchart of the steps of a forming method of a metal layer shown according to an embodiment of the disclosure. FIG. 2A to FIG. 2C are cross-sectional views of a process of a forming method of a metal layer shown according to an embodiment of the disclosure. Referring to FIG. 1 and FIG. 2A simultaneously, in step 100, a plurality of metal particles 202 are provided on a substrate 200. The substrate 200 may be various substrates on which a metal layer is to be formed, and the disclosure is not limited in this regard. The metal particles 202 may also be referred to as metal powders, and the material thereof may be a metal or an alloy. In the present embodiment, the metal particles 202 may be aluminum particles, stainless-steel particles, tin particles, titanium particles, zinc particles, magnesium particles, zirconium particles, or chromium particles, but the disclosure is not limited thereto. In the present embodiment, the method of providing the metal particles 202 on the substrate 200 is, for example, a process such as inkjet, spraying, or micro-dispensing, but the disclosure is not limited thereto.

Generally, after the metal particles 202 are provided on the substrate 200, a layer of metal oxides 204 is generated on the surface of the metal particles 202 due to the oxidation of oxygen in the external environment.

Then, in step 102, an oxide-removing agent 206 is applied to the metal particles 202 to remove the metal oxides 204 on the metal particles 202. In the present embodiment, the oxide-removing agent 206 is, for example, an organic acid, an inorganic acid, a flux, or carbon particles. The organic acid is, for example, oxalic acid, acetic acid, citric acid, or a combination thereof. The inorganic acid is, for example, phosphoric acid, sulfuric acid, or a combination thereof. When carbon particles are used as the oxide-removing agent 206, the carbon particles need to be applied to the metal particles 202 under a hydrogen atmosphere to reduce the metal oxides 204 on the metal particles 202 to a metal. A suitable oxide-removing agent 206 may be selected depending on the type of the metal particles 202. For example, when the metal particles 202 are stainless-steel particles, oxalic acid is selected as the oxide-removing agent 206 to effectively remove the oxides from the stainless-steel particles. Further, when the metal oxides 204 on the metal particles 202 are removed by the oxide-removing agent 206, the impurities attached to the metal particles 202 are also removed at the same time. As a result, the sintered body formed in a subsequent step does not contain metal oxides and impurities, and a metal sintered body having high purity may be formed.

The oxide-removing agent 206 may be applied to the metal particles 202 in a variety of ways. For example, the oxide-removing agent 206 may be applied to the metal particles 202 using inkjet, micro-dispensing, or spraying. In the present embodiment, the oxide-removing agent 206 may be applied to the metal particles 202 by a nozzle 208. Further, in the above manner, the oxide-removing agent 206 may be applied to the metal particles 202 of a specific region or applied to all of the metal particles 202. As shown in FIG. 2A, the oxide-removing agent 206 may be applied to the metal particles 202 located in the intermediate region by the nozzle 208. In addition, when spraying is employed, the oxide-removing agent 206 may be applied to the metal particles 202 over a large area. Therefore, the metal oxides 204 on the metal particles 202 may be quickly removed. Additionally, for specific oxide-removing agents, the metal oxides need to be removed at a particular activation temperature. Therefore, the treatment temperature is raised to the above activation temperature during the application of the oxide-removing agent.

Next, referring to FIG. 1 and FIG. 2B simultaneously, in step 104, the metal particles 202 for which the metal oxides 204 are removed are heat-treated at a first temperature to form a near shape 210. The first temperature depends on the material of the metal particles 202, and the disclosure is not limited thereto. In detail, after the metal oxides 204 on the metal particles 202 are removed using the oxide-removing agent 206, the metal particles 202 are exposed. Therefore, the metal oxides 204 may be melted without using a high-temperature heat treatment, and the metal particles 202 may be directly subjected to a low-temperature heat treatment to form the near shape 210. During the low-temperature heat treatment, a necking effect is generated between the metal particles 202 (this step may be referred to as low-temperature calcination), and the shape of the metal layer formed at this time is referred to as a near shape. Therefore, compared with directly sintering the metal particles having metal oxides formed on the surface at a high temperature via high-energy laser in the prior art, in the present embodiment, the metal particles are first formed into a near shape by a low-temperature heat treatment to shorten the time of subsequent high-temperature sintering.

In particular, when the oxide-removing agent needs to remove the metal oxides at the activation temperature, the activation temperature is typically lower than the first temperature. Further, in some embodiments, after the metal oxides are removed at the activation temperature, the temperature may be directly raised from the activation temperature to the first temperature to continuously perform the heating.

Next, referring to FIG. 1 and FIG. 2C simultaneously, in step 106, a second heat treatment is performed at a second temperature higher than the first temperature, so that the near shape 210 is formed into the sintered body 212 having a dense structure. The second temperature depends on the material of the metal particles 202, and the disclosure is not limited thereto. In the present embodiment, the second heat treatment may be performed using low-energy laser, an oven, or an electron beam (this step may be referred to as high-temperature sintering). Since in step 104, the metal particles 202 first generate a link effect at a lower first temperature to form the near shape 210, in step 106, the sintering time at a higher second temperature may be shortened and the resulting dense sintered body 212 does not have metal oxides and impurities and has high purity. As a result, the metal layer formed by the sintered body 212 of the present embodiment may have stable and desirable characteristics.

The effects of the forming method of a metal layer of the disclosure are described below by experimental examples and a comparative example.

### Experimental Example 1

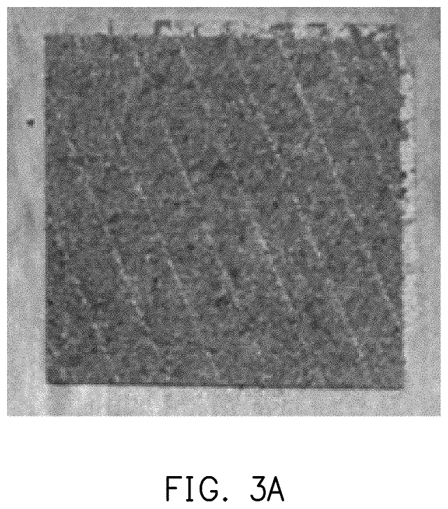

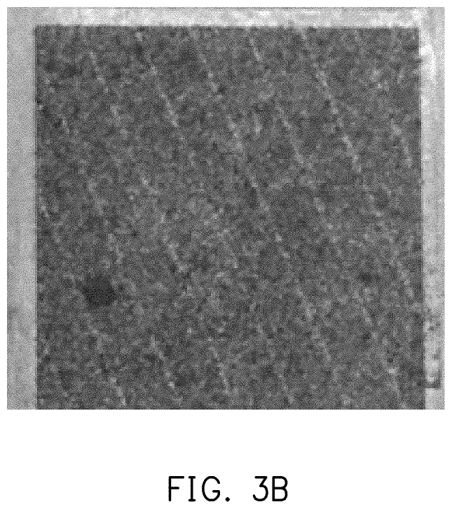

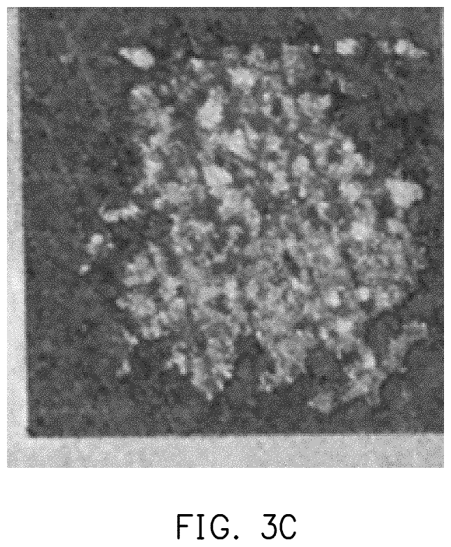

Stainless-steel particles were used as metal particles, and after being provided on a substrate, oxalic acid (pH about 2) was used as an oxide-removing agent to remove oxides on the stainless-steel particles (melting point about 1565° C.), then low-temperature calcination was performed at 800° C. to generate a link effect between the stainless-steel particles to form a near shape, and the result is shown in FIG. 3A.

### Experimental Example 2

Stainless-steel particles were used as metal particles, and after being provided on a substrate, flux (potassium fluoroborate, KBF₄) was used as an oxide-removing agent to remove oxides on the stainless-steel particles, then low-temperature calcination was performed at 800° C. to generate a link effect between the stainless-steel particles to form a near shape, and the result is shown in FIG. 3B.

### Comparative Example 1

Stainless-steel particles were used as metal particles, and after being provided on a substrate, low-temperature calcination was directly performed at 800° C. At this time, a link effect could not be generated, and the result is shown in FIG. 3C.

As may be seen from FIG. 3A, FIG. 3B, and FIG. 3C, the oxides on the stainless-steel particles were removed with the oxide-removing agent after the stainless-steel particles were provided on the substrate, so that a link effect may be formed after the low-temperature heat treatment (as shown in FIG. 3A and FIG. 3B), and stainless-steel particles for which oxides were not removed using the oxide-removing agent could not form a link effect after the low-temperature heat treatment (as shown in FIG. 3C). As a result, in Experimental example 1 and Experimental example 2, since the near shape was formed first, the time for the subsequent high-temperature heat treatment to form a sintered body may be shortened, and a sintered body of high purity may be formed.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A forming method of a metal layer suitable for a 3D printing process, the forming method of the metal layer comprising:
providing a plurality of metal particles on a substrate;
applying an oxide-removing agent on the metal particles to remove metal oxides on the metal particles;
performing a first heat treatment on the metal particles for which the metal oxides are removed at a first temperature to form a near shape; and
performing a second heat treatment on the near shape at a second temperature to form a sintered body,
wherein the first temperature is lower than the second temperature.

2. The forming method of the metal layer of claim 1, wherein the oxide-removing agent comprises an organic acid, an inorganic acid, a flux, or carbon particles.

3. The forming method of the metal layer of claim 2, wherein the organic acid comprises oxalic acid, acetic acid, citric acid, or a combination thereof.

4. The forming method of the metal layer of claim 2, wherein the inorganic acid comprises phosphoric acid, sulfuric acid, or a combination thereof.

5. The forming method of the metal layer of claim 2, wherein the carbon particles are applied to the metal particles in a hydrogen atmosphere.

6. The forming method of the metal layer of claim 1, wherein a method of applying the oxide-removing agent comprises inkjet, micro-dispensing, or spraying.

7. The forming method of the metal layer of claim 1, wherein a material of the metal particles comprises a metal or an alloy.

8. The forming method of the metal layer of claim 1, further comprising applying the oxide-removing agent to the metal particles at an activation temperature of the oxide-removing agent, and the activation temperature is lower than the first temperature.

9. The forming method of the metal layer of claim 8, further comprising directly increasing a temperature to the first temperature at the activation temperature after the metal oxides on the metal particles are removed.
